(19) United States
(12) Patent Application Publication
(10) Pub. No.: US 2015/0300975 A1
(43) Pub. Date: Oct. 22, 2015

(54) Electrophysiological Measuring Arrangement, and Electrophysiological Measuring Method

(71) Applicant: Universität Rostock, Rostock (DE)

(72) Inventors: Oliver Klink, Rostock (DE); Philipp Julian Koester, Rostock (DE); Carsten Tautorat, Rostock (DE); Uwe Scheffler, Broderstorf (DE)

(21) Appl. No.: 14/377,199

(22) PCT Filed: Feb. 7, 2013
(86) PCT No.: PCT/EP2013/000369

§ 371 Date: Aug. 7, 2014

(30) Foreign Application Priority Data
Feb. 8, 2012 (DE) 102012002459.2

(51) Int. Cl. G01N 27/327

(52) U.S. Cl. CPC G01N 27/327

(57) ABSTRACT

The invention relates to an electrophysiological measuring arrangement (100) and an electrophysiological measuring method in which a biological object (O) to be examined is sealingly deposited in a controllable manner on a support (12) of the measuring arrangement (100). A control electrode arrangement (20) is embedded in the interior of a wall region (11) which forms an aperture (14) of an aperture region (10). An electric potential can be applied to the control electrode arrangement in a controllable manner such that a surface charge of at least the inner wall (11i) of the wall region (10), said inner wall facing the aperture (14), can be generated in a controllable manner in terms of strength, variation over time, geometry, and/or polarity in order to thus prevent or support the sealing depositing process in a controlled manner in interaction with the membrane of the biological object (O) to be examined.

### FIELD OF INVENTION

The present invention is concerned with an electrophysiological measuring arrangement as well as with an electrophysiological measuring method.

### BACKGROUND

In the field of electrophysiology different methods and arrangements are used to scrutinize biological objects—hence, in particular cells in its widest mean, cell organelles, oocytes and their fragments—with respect to proteins and their transport characteristics integrated and/or deposited in respective membranes, wherein also vesicle, liposomes or other more or less artificial systems can be used. In this process, often electrical currents and/or electrical voltages between a measurement electrode and a counter electrode, between which the biological object is disposed, are measured, which should give information about the underlying physiological processes, in particular transport processes, conformation changes and the like.

Because of the comparably very low signal strengths, which are often obtained, for achieving a suitable signal-to-noise ratio high sealing resistances, i.e. electrical residual conductivity as low as possible, over the membrane itself or in the contact region between the membrane of the biological object to be scrutinized and the aperture wall are advantageous.

Up to now the sealing resistance and the electrical residual conductivity between the interior and the outside of the cell—or more general between the inside and the outside of the membrane—of the biological object to be measured cannot be controlled with the known electrophysiological measuring methods and measuring arrangements in a sufficient manner. Therefore, in general sealing resistances are often too low such that an unfavourable signal-to-noise ratio is obtained. However, often also precisely depositing and forming of a sealing resistance itself is particularly bad controllable over time such that for example already during preparation of a measurement depositing in the measuring arrangement, which is at this moment still undesired, may appear, which, if dissolved, leads to a contamination and hence to a deterioration of further, than desired depositing, or which prevent a later depositing at all.

### SUMMARY OF THE INVENTION

The invention solves the problem to provide an electrophysiological measuring arrangement as well as an electrophysiological measuring method, which make it possible to control depositing of a biological object to be measured as well as the forming of a sealing resistance during the depositing between the biological object to be measured and the measured system as reliable as possible.

The object of the present invention is solved with an electrophysiological measuring arrangement according to the invention with the features of independent claim 1. Further, the object of the invention is solved by an electrophysiological measuring method according to the invention with the features of independent claim 10. Advantageous embodiments are described in the dependent claims.

The present invention provides on the one hand an electrophysiological measuring arrangement with an aperture region—i.e. with a region, which comprises or forms at least one aperture or measurement aperture—for controlled sealing depositing of a biological object, e.g. a cell, a cell organelle, a vesicle, a liposome, a natural or artificial membrane, e.g. of a lipid double layer, or the like or of a fragment thereof. To this end, the aperture region is formed with the at least one aperture as well as a wall region, which surrounds the aperture to form it. The wall region comprises embedded into its interior a control electrode arrangement. The control electrode arrangement is controllable such with an electrical potential applied to it that by this process at least an inner wall of the wall region, which is facing the aperture, can be formed controllable with a surface charge such that by this the sealing depositing of a biological object at the aperture region is controllable.

Alternatively or additionally the direct or indirect influencing of molecules close to the walls can be performed by electrical fields as well as e.g. also by generating ring currents, e.g. also by induction, i.e. electromagnetically.

It is therefore a main idea of the present invention to provide in an electrophysiological measuring arrangement with an aperture region, which is formed for sealing depositing, i.e. for depositing with high sealing resistance with respect to a biological object to be analysed, in a wall region, which forms and surrounds an aperture of an aperture region, embedded into its interior a control electrode arrangement. This control electrode arrangement is electrically isolated with respect to the rest of the measuring arrangement—in particular with respect to the biological object, an electrolyte bath, in which the biological object is contained and possible measurement and counter-electrodes—and an electrical potential may be controllably applied to it to form at least at or within the inner wall of the wall region, i.e. facing the aperture, a surface charge in a controlled manner.

The controlled forming of the surface charge leads then due to an according electric interaction to the result that also the sealing depositing of a biological object to be scrutinized can be controlled, namely either by provoking a repelling interaction, which prevents an undesired depositing and hence a contamination to be prevented, or by supporting via an attracting interaction a depositing and a sealing by a seal with respect to the biological object to be scrutinized.

Hence, according to the invention it is possible to prevent in a preparing phase of a measurement a depositing and a seal, in order to force during the actual measurement phase—or directly before it—the desired biological object to deposit and to form a seal with the aperture and the wall region of the aperture and to improve the strength of the seal in the meaning of an increased sealing resistance or a strongly reduced residual conductivity as well as an increased mechanical stability of the seal.

In this process as biological objects, to which an analysis can be applied, cells, cell organelles, oocytes, bacteria or their combinations or fragments, all in its widest meaning, may be used. Further, artificial or partially artificial in principle biological structures are conceivable, for example in form of vesicles, liposomes, micelles, membrane fragments or the like, into which proteins are embedded and/or adsorbed in a natural or artificial manner.

The object to be scrutinized may in general be natural or partially or completely artificial biological objects. In addition, also non-biological objects may be scrutinized, to analyse e.g. pure lipid structures and their modifications. In what follows only biological objects are described, by which, however, all variations as described above should be comprised as measurement objects.

Differently stated, according to the invention it is achieved that on the one hand in a preparing phase contaminations of the depositing region, i.e. the walls of the aperture, can be prevented. On the other hand, selected biological objects to be scrutinized can be deposited with a improved sealing resistance and measured thereafter such that a better signal-to-noise ratio is achieved and that the depositing is stabilized mechanically, e.g. with the result of an extended measurement period and an improved reliability with respect to the measurement results. In addition, according to the invention the possibility exists to reduce or to even remove a possibly already occurred contamination of the depositing region, i.e. for example the aperture wall, by applying an accordingly chosen direct voltage or alternating voltage by the control electrode arrangement.

By choosing the polarity of the electrical potential applied to the control electrode arrangement the polarity of the surface charge at the inner side of the wall or inner wall of the wall region of the aperture is influenced accordingly. In this process, type and strength of the interaction may be influenced depending on the charge of the membrane of the biological object on its outer and inner side.

According to an embodiment of the measuring arrangement according to the invention the aperture region is formed in a region of a support, which has an upper side and a lower side. Then, a corresponding wall region forming an aperture may partially or totally protrude with respect to the upper and/or with respect to the lower side of the support. The support to be provided may also be designated as basis, substrate or basic substrate. Providing such a substrate or such as support mechanically stabilizes the measuring arrangement and in particular the arrangement of the arranged biological object to be scrutinized as such and allows a macroscopic partitioning of the measuring arrangement with respect to the electrolyte bath on which the measurement is based as defined by the partitioning of a measurement cuvette or wet cell in compartments with measure and counter-electrode.

A corresponding wall region forming an aperture may also be formed integrally within the inner wall of the hole in combination with the electrode arrangement.

Based on the substrate or the support one or several apertures with respective wall regions may be formed protruding or outpointing with respect to the upper side. Alternatively to this, these may be put over to the inside to be planar and flush with the upper side, and to protrude at the lower side of the support or the substrate; however, this is not necessary and may be omitted in case of an according thickness of the membrane. The degree of the respective invagination or protrusion influences the inner wall of the respective wall region and due to this the available interaction area with the membrane of the biological object. Choosing the degree of invagination or protrusion allows additionally an adjustment to the respectively available measurement objects, for example with respect to their form or number in the measurement solution.

The support may also be formed as a—in particular planar—plate element with front or upper side and with rear or lower side. Also other geometries are conceivable.

Alternatively one may deviate from the plate-like form by using the form of a pipette, e.g. within the meaning of a classical patch pipette.

A wall region forming an aperture may also be formed in the manner of a lateral surface or as a combination of later surfaces. To this end, the lateral surface of a cylinder, a prism, a truncated cone and/or pyramid may be used, respectively, with according wall thickness. With respect to the form of the wall region for forming the aperture there are hence a plurality of possibilities. These may be chosen depending on the form and the further—e.g. mechanical, geometrical and/or electrical—features of the biological object to be scrutinized.

Alternative to this the wall region forming an aperture may be formed by an edge or edge region such that the aperture is formed quasi as a planar hole within the underlying substrate and the control electrode arrangement is embedded into the edge region of the planar hole and applies an according surface charge to influence depositing and sealing in a supporting or inhibiting manner.

A wall region forming an aperture may be formed with or from a material from the group of materials, which comprises glass, quartz glass, silicon, carbon and their combinations and derivatives. Also with respect to the choice of materials the features of the underlying biological object may be taken into account, for example with respect to the surface structure or surface charge of the outside of the membrane and/or the inside of the membrane of the biological object, for example also to support a particularly strong adhesion and hence the increasing of the sealing resistance during sealing.

The control electrode arrangement may comprise one or more electrode elements integrated or embedded within the aperture forming wall region. These may have arbitrary forms, in particular forms of circles, stripes and the like. However, all forms are conceivable for the electrode elements of the control electrode arrangement, as long as it is guaranteed that an electric isolation with respect to the electrolyte bath, the biological object to be scrutinized, and in particular with respect to the electrodes of the measurement electrode arrangement and the counter-electrode arrangement is guaranteed. Further, form and number of electrode elements may depend on the configuration, the form and the structure of the aperture, and the wall region. This may also advantageously be used for better controllability and in particular for intensifying the interaction of the biological object with the wall region of the aperture.

The electrodes may also have a specific distance to the wall surface depending on the electric field to be generated and depending on simple integrability of the electrodes.

The control electrode arrangement and in particular its electrode elements may be asymmetrically formed with respect to the wall thickness of an or the aperture forming wall region and may in particular be arranged closer to the inner wall, which faces the aperture. Also this may serve for the adaption of the geometry of the potential and hence the interaction between the biological object and the aperture and its wall region.

The control electrode arrangement and in particular its electrode elements may be formed with or from a material from the group of materials, which comprises metallic materials, gold, tantalum, platinum, gold-tantalum-platinum, doped, in particular highly doped, polysilicon, indium-tin-oxide, electrical conductive organic materials and their combinations and derivatives. Basically, however, all electrically conductive or partly electrically conductive materials are conceivable that allow transmitting an electrical potential, wherein in addition also manufacturing aspects may be taken into account. In particular, it may also be considered to use conductive organic materials, doped semiconductor materials or the like, as long as there exist no procedural obstacles, for example with respect to stability of the used materials at high process temperatures or the like.

The diameter of the aperture and in particular the inner diameter of one or of the wall region forming the aperture may have a value in the range of about 0 μm to about 50 μm, preferably in the range from about 1 μm to about 50 μm. One or the wall region forming an aperture may have a height or depth in the region of about 0 μm to about 20 μm extending above the upper side or the lower side of the support or the substrate.

The indication of those dimensions should not to be considered to be limiting. Instead, the dimensions with respect to height and depth of the wall regions and their diameter are based on the geometrical setting and the biological objects to be scrutinized, in particular on their size and on the mechanical characteristics of their membranes.

For forming a measurement loop a measurement electrode may be provided in the region of or within the aperture or in a region at the rear or lower side of the support or substrate.

A counter-electrode may be provided outside of the aperture and in the region at the front or upper side of the support.

Measurement electrode and counter electrode are preferably arranged on opposing sides of the support or substrate or the measurement aperture, however, such that at depositing of a preferably biological object to be measured the biological object is arranged between the electrodes and practically separate these by forming a suitable seal, preferably with a very high resistance, ideally larger than 1 GΩ.

The basic setup of the electrophysiological measuring arrangement according to the invention comprises according to this embodiment in particular providing of a measurement electrode arrangement and a counter-electrode arrangement, between which an electric current and/or an electric voltage may be measured, wherein between the measurement electrode arrangement and the counter electrode arrangement in particular the biological object to be measured is arranged in the region of the aperture and its wall region such that by the sealing depositing the residual conductivity, i.e. the conductivity between the membrane of the biological object and the wall region of the aperture is as small as possible such that the actually measured electrical currents and/or electrical voltages can be assumed to be generated from the features of the membrane of the biological object, for example due to transport processes, charge displacements within or across the membrane, by substrate binding or disposal or the like.

According to a further aspect of the present invention an electrophysiological measuring method is developed. The method is carried out in particular by using an electrophysiological measuring arrangement according to the present invention. To this end, for controlling a sealing depositing of a biological object to be measured at an aperture of an aperture region on the inner wall of an aperture forming wall region a surface charge is formed in a controlled manner, in particular by direct or indirect influencing of molecules close to the wall region by electrical fields, by generating of ring currents and/or by induction, i.e. electromagnetically, wherein in particular for preventing of a sealing depositing a negative surface charge and for supporting of a sealing depositing a positive surface charge may be formed. According to the electrical characteristics of the membrane to be deposited the polarities have to be chosen reciprocally if necessary.

By suitable alternating voltage depositions may also be modified, e.g. within the meaning of a dielectrophoresis.

Hence, by the measuring method according to the invention also a direct influencing of molecules close to the wall by electrical fields or also by inducing ring currents, e.g. also inductive, i.e. electromagnetically, may occur.

Accordingly, a main aspect, which underlies the electrophysiological measuring method according to the invention is thus a controlled applying of the aperture and in particular its wall region with a surface charge, which controls via an electrical interaction with a biological object a sealing depositing within the meaning of a supporting or a preventing. In this process, an influencing of the field not only directly on the wall surface, but also influencing of the field in a distance from the wall may occur.

Within the measuring method according to the invention and the measuring arrangement according to the invention measurement signals may be measured in particular also in a capacitive manner to deduce e.g. single channel activities.

By charging the control electrode arrangement according to an invention biological objects to be analysed, i.e. e.g. cells, may—e.g. within the meaning of an electroosmosis—be repelled, inserted etc.

Using several control electrodes or a modified setup it is also possible according to the invention to accordingly model an electric force in its field profile to focus the force e.g. by choosing a suitable field geometry and/or realize a standard protocol.

This and further aspects of the present invention will be discussed on basis of the accompanying drawings.

### BRIEF DESCRIPTION OF THE FIGURES

FIG. 1A shows in a sectioned side view a first embodiment of the electrophysiological measuring arrangement according to the invention, in which the wall region of an aperture extends above the upper side of an underlying support.

FIG. 1B-1D show in schematic and sectioned plane view different cross-sectional forms of an aperture and the respective underlying wall region.

FIG. 2A, 2B show in schematic and sectioned side view details of the formation of surface charge at the wall region of an aperture for a symmetrical or an asymmetrical arrangement of the control electrodes in the wall region.

FIGS. 3-7 show in an analogue manner to FIG. 1A in schematic and sectioned side view embodiments of an electrophysiological measuring arrangement according to the present invention, in which a respective aperture is formed by wall regions, which correspond to lateral surfaces of different geometrical bodies.

FIG. 8 shows an electrophysiological measuring arrangement according to an embodiment of the present invention, which is formed in the manner of a so-called patch pipette.

FIG. 9A-9E show in schematic and sectioned side view different aspects of the use of the electrophysiological measuring arrangement according to the present invention.

FIGS. 10-12 show in schematic and sectioned side view details of depositing of a biological object to respective embodiments of the electrophysiological measuring arrangement.

### DETAILED DESCRIPTION OF THE EMBODIMENTS

In the following embodiments of the present invention are described. All embodiments of the invention and also their technical features and characteristics may be separately isolated and be arbitrarily assembled facultatively with each other and may be combined without limitation.

Structurally and/or functionally identical, similar, or identically acting features or elements are in the following designated with the same reference numerals within the Figures. A detailed description of these features or elements will not be repeated in each case of their appearance.

First, reference is made to the drawings in general.

In electrophysiology amongst others the patch clamp technique is used to carry out e.g. ion channel analysis for medicament testing. In using manual patch clamp methods and its refinements electric currents and voltages may—e.g. on single cells—be measured, which are—e.g. by ion channels—be generated in membranes of biological cells.

Because of the growing importance of electrophysiological analysis and the personal and temporal effort of its execution a large demand for automated electrophysiological measurement techniques and in particular for planar patch clamp and further automated patch clamp or APC systems has occurred.

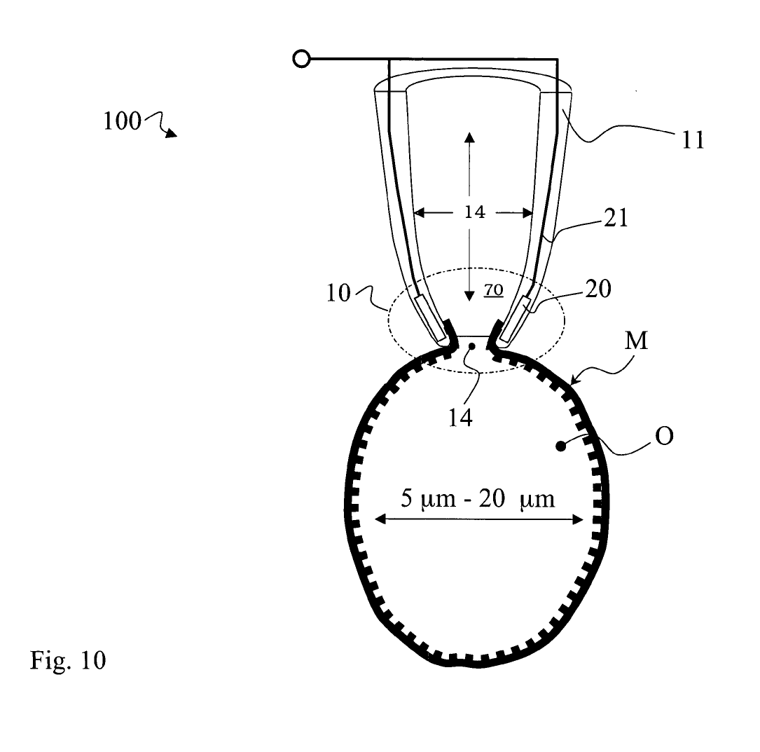

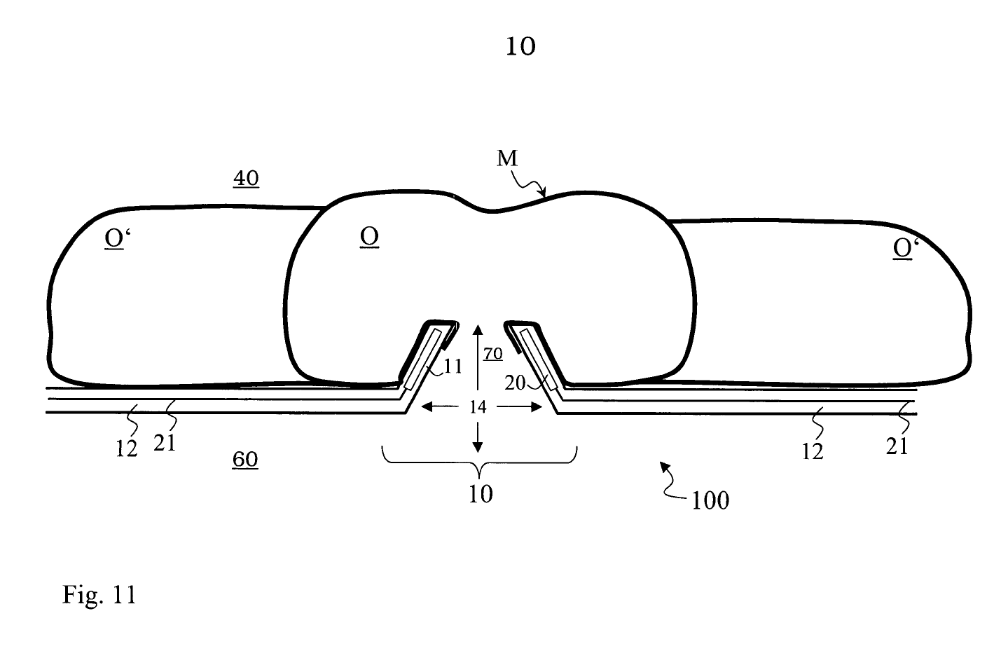

The way of functioning of the manual patch clamp method and of APC systems are basically the same. Within both types of systems the necessity of forming a high ohmic sealing resistance between the measurement object O, e.g. a cell, and the measuring arrangement 100 is problematic. A so-called gigaseal is necessary, i.e. a sealing resistance within an order of gigaohms. Then, electrical isolation—e.g. of the cell interior with respect to the outside of the cell—is described e.g. by a patch pipette, as is e.g. shown in FIG. 10, or in case of a planar cell arrangement according to an APC scheme according to FIG. 11.

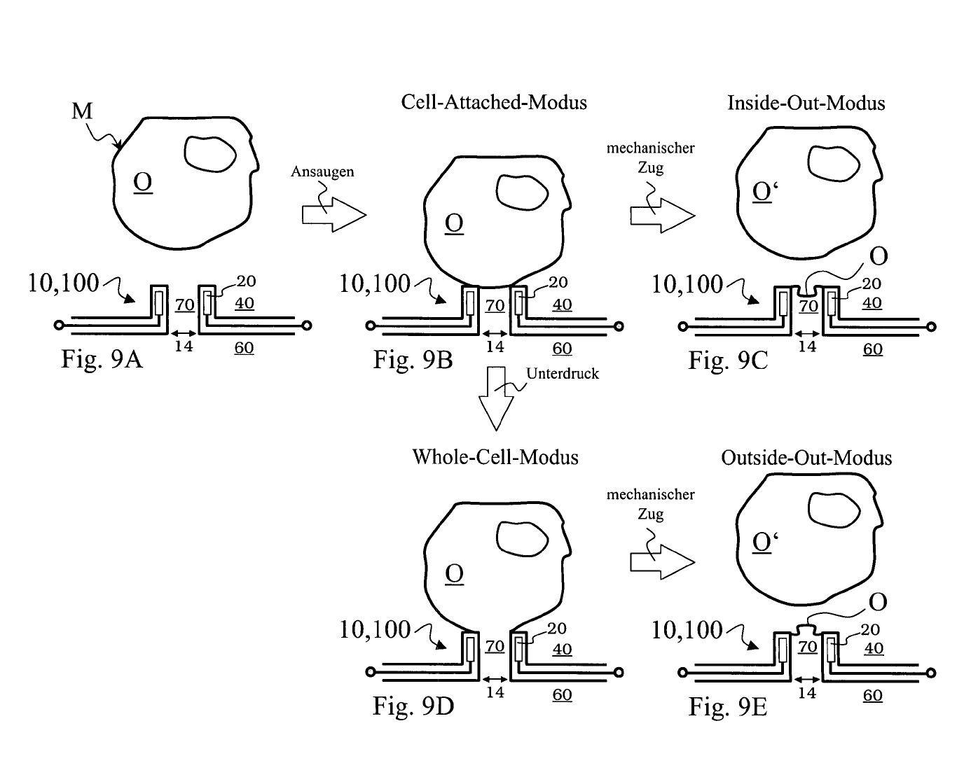

By using a patch pipette a cell is aspirated as biological object O if needed. In this process, a small limited part of the cell membrane, which is called a patch, is sucked in with a small underpressure. In this process, according to the cell-attached-measurement according to FIG. 9B the measurement area or according to a whole-cell-measurement according to FIG. 9D the cell interior is electrically sealed in the megaohm to gigaohm region with respect to the outside of the cell. The cell-attached configuration allows a current measurement also at separated ion channels within the cell membrane.

In the manual patch clamp as well as in APC-systems the gigaseal rate as well as the sealing resistance are a measure for the quality of the possible ion channel measurements. Up to now, a 100% gigaseal rate is not possible.

Forming of the gigaseal depends on many factors, which are up to now not available to active influencing. Hence, a real control of the gigaseal is missing within the measurement process.

In manual patch clamp methods a sufficiently high gigaseal rate can only be achieved with newly formed glass pipettes. In developing of APC systems attention have to be paid to a reduction of the surface roughness and to avoiding of sharp edges. Further, a careful combination of the intra- and extra-cellular buffers may lead to an improvement of the gigaseal. However, because of the necessity to use physiological buffers this provides only limited possibilities. In addition, all improvements have to be considered before the actual experiment.

In automated measurement systems, in particular for cell networks or cell cultures cells O within the adhering culture may form a gigaseal spontaneously and undesirably. A gigaseal is however a temporally limited process, at which end the gigaseal is pulled off and therefor a consecutive new forming of a seal and hence a new measurement is prevented. Using a pipette and its aperture 14 anew is then not possible anymore.

Hence, in particular automating of a control of the gigaseal is necessary. Up to now this is not possible.

The present invention is based on the insight that negative or positive charges at or in the inner wall 11i of a measurement aperture 14, e.g. also of a patch pipette, may support forming of a gigaseal or improve the gigaseal itself. By a directed, spatially resolved increase of the charge density—by means of positive or negative charges—at or within the inner wall 11i of the measurement aperture 14 processes for establishing or for suppressing a gigaseal become influenceable, wherein also electrokinetic effects under the use of alternating fields may be used if necessary.

Controlling the charge density at or within the pipette wall 11 is achieved according to the invention by integrating a conductive control electrode 20, which is isolated towards the inner side of the measurement aperture 14, e.g. in form of a layer 20, into the measurement aperture wall 11 together with applying of predetermined voltages and a counter-electrode 30, 50.

Controlling of these structures is performed via a controllable voltage source. This conductive control electrode 20 may be symmetric to the measurement aperture 14. The counter-electrode may be for example the measurement electrode 30, 50 of the measurement or patch clamp system, which is connected via a conductive liquid 40, 60 within the measurement aperture 14 or by an electrode specifically provided to this end.

The setup may correspond as far as possible to a cylinder capacitor. Particularly preferable is an embodiment in which the isolation layer between the electrode 20 or the conductive layer 20 and the measurement aperture 14 is particularly thin. Charge displacements effect an accumulation of only positive or only negative charges at or within the inner side 10i, 11i of the measurement aperture 14.

Hence, the invention serves controlled establishing or suppression of a sealing depositing of a biological object O, e.g. of a cell or the like, within the meaning of a gigaseal by generating and controlling of charge densities at or within the inner wall 10i, 11i of the measurement aperture 14.

This is achieved according to invention by integrating an isolated conductor 20 into the wall 11 of the measurement aperture 14.

The comparably high charge density made possible by the invention, may it be negative or positive, cannot be achieved conventionally. In the presented invention, however, the measurement aperture can always be controllably electrically charged.

The present invention relates therefore to an electrophysiological measuring arrangement 100 as well as to an electrophysiological measuring method, in which the sealing depositing of a biological object O to be analyzed on a support 12 of the measuring arrangement 100 can be controlled by providing within a wall 11, which forms an aperture 14 of an aperture region 10, embedded into its interior a control electrode arrangement 20, to which an electrical potential is controllably applicable such that by this process at least the inner wall 10i, 11i of the wall region 11, which faces the aperture 14 can be controllably—in strength, temporal and spatial distribution and/or polarity—formed with a surface charge, to controllably suppress or support via interaction with the membrane of the biological object O to be analysed the sealing depositing.

By using a suitable chosen electrode combination also a circular current in a pipette or in general in the region of an aperture may be generated by which the depositing of a measurement objection would be suppressible also.

Now reference is made to the drawings in detail.

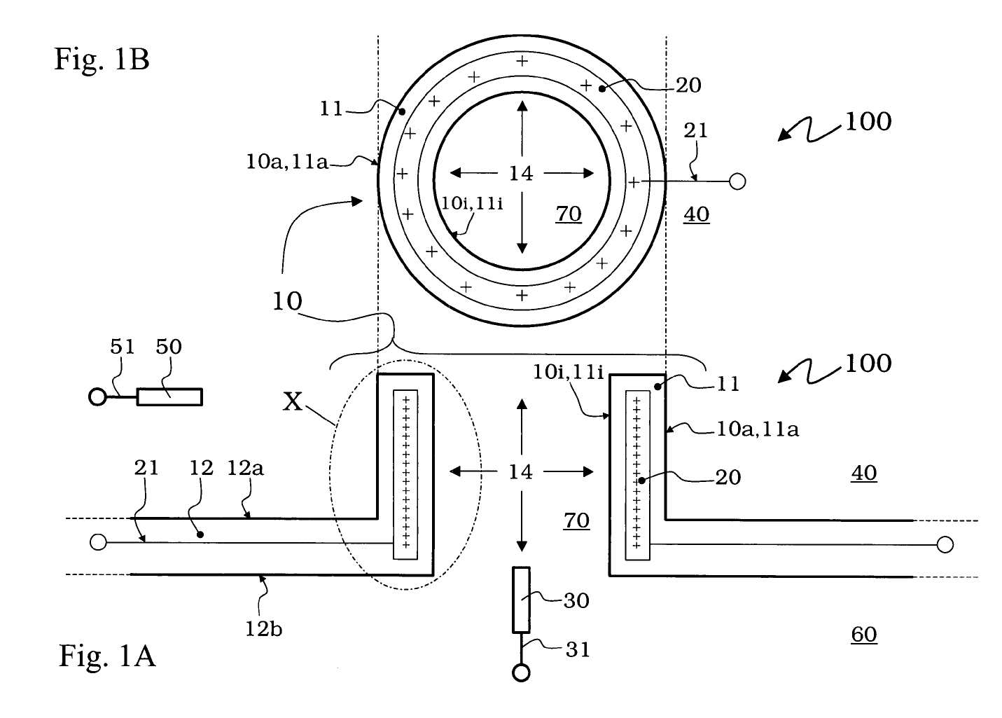

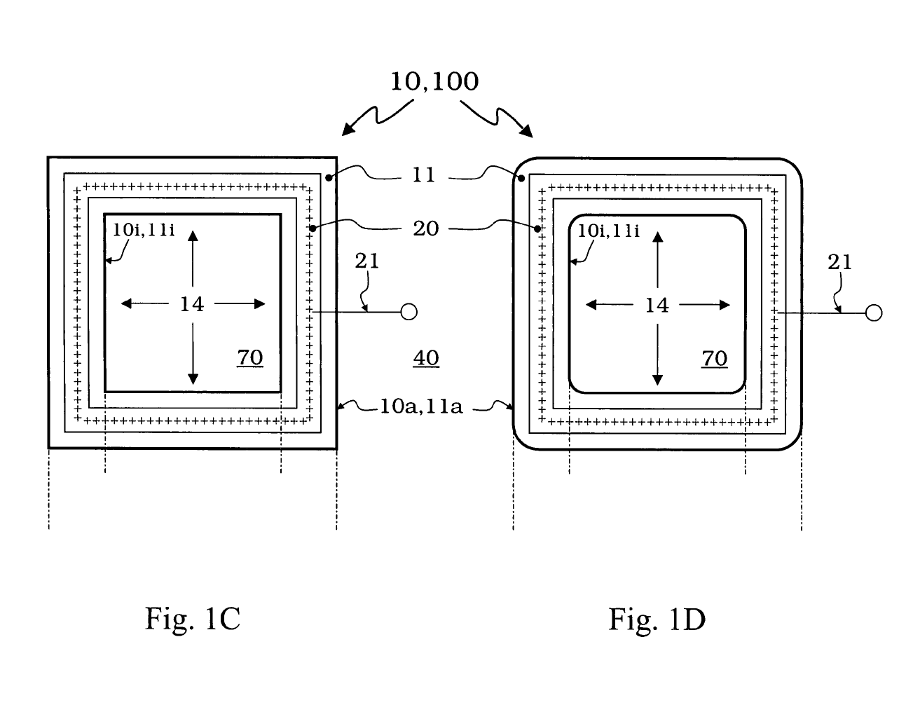

FIG. 1A shows in schematic and sectioned side view a first embodiment of the electrophysiological measuring arrangement 100 according to the invention.

A basic element of this embodiment is the support 12, which may also be denoted as basis 12 or substrate 12. This support 12 partitions an electrolyte bath 40, 60, 70 provided during the measurement in at least two compartments, wherein the first compartment 60 faces the lower side 12b of the support 12 or substrate 12 and wherein the second compartment 40 faces the upper side 12a of the support 12 or substrate 12.

Into the support 12 a so-called aperture region 10 is incorporated. The aperture region 10 comprises at least one aperture 14, namely e.g. in the manner of a through hole, which locally penetrates the support 12 in the direction of its layer thickness totally, namely in the direction from the upper side 12a to the lower side 12b. In the region of the aperture 14 a part 70 of the electrolyte bath 40, 60, 70 is also provided.

All together viewed it exists thus between the upper side 12a and the lower side 12b via the aperture 14 of the aperture region 10 a fluid-mechanical connection and accordingly via the possibly present conductivity of the electrolyte bath, often a physiological solution is used in this process during application, also an electric connection.

In the embodiment according to FIG. 1A a counter-electrode 50 to a measurement electrode 30, which is provided at the lower side 12b of the support 12, is arranged in the upper side compartment 40 and is connected via a conductor 51. The measurement electrode 30 is therefore located in the lower side compartment 60 of the electrolyte bath 40, 60, 70 and is connected via a conductor 31. The conductors 51 and 31 to the counter electrode 50 or to the measurement electrode 30 are isolated by itself and lead to a corresponding control and measurement loop, which is not illustrated.

Within the substrate 12 runs—also coming from the control and measurement loop—a control conductor 21, which leads to the control electrode arrangement 20. This control electrode arrangement 20 is formed within the wall region 11 in its interior and is hence electrically isolated with respect to the electrolyte bath 40, 60, 70 and also with respect to the measurement electrode 30 and the counter-electrode 50.

Alternatively the control electrode arrangement 20 may not be formed as a bar, but e.g. in the manner of a cone such that its form defines the charge carrier density—in this case possibly a single electrode would be sufficient, which is however modified in an adapted manner. Besides this, additionally or alternatively partitioned electrodes of the control electrode arrangement 20 are conceivable, in particular also in the context of an alternating voltage operation.

The wall region 11 by itself forms a closed wall in the form of a lateral surface with an inner side 10i, 11i or inner wall 10i, 11i and an outer side 10a, 11a or outer wall 10a, 11a. In this manner an aperture 14 of the aperture region 10 of the electrophysiological measuring arrangement 100 according to the invention is formed, wherein the inner side or the inner wall 10i, 11i of the wall region 11 faces the aperture 14, the outer wall or outer side 10a, 11a of the wall region 11 is in contrast averted from the aperture 14, however facing the compartment 40 of the electrolyte bath 40, 60, 70.

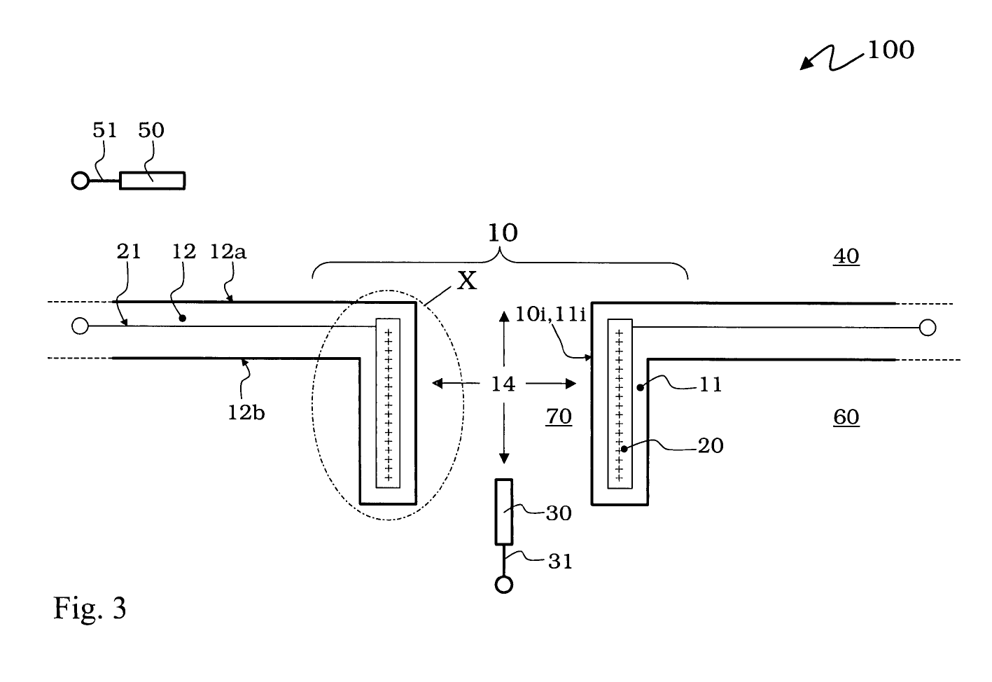

In the embodiment of FIG. 1A the wall region 11 extends exclusively beyond the upper side 12a of the support or substrate 12. At the lower side 12b of the substrate or support 12 the aperture region 10 is formed quasi planar. Such a structure is however not necessary and FIGS. 3 to 7 show embodiments modified in this regard, which will be described in detail later.

As explained above the wall region 11 which forms the aperture 14 is formed in the manner of a lateral surface of a geometric body. According to FIG. 1B this lateral surface may stem in synopsis with FIG. 1A from an upright circular cylinder as basic form.

In FIGS. 1A and 1B the control electrode arrangement 20 connected via the conductor 21 is applied with positive electric charges. However, this is only an example. According to the situation and to the object to be analyzed an electric potential may be applied to the control electrode arrangement 20 such that a suitable interaction is formed.

The forming as lateral surface of an upright circular cylinder as basic form is not mandatory. FIGS. 1C and 1D show instead of a cylinder form in schematic plane view as base area a quadrate such that spatially an upright quadratic prism results or a prism with a base area in the form of a oval, quasi of a quadrate or rectangle with rounded corners, as it is illustrated in FIG. 1D.

Basically arbitrary forms of the base area are possible. However, according to the circumstances described above, according to which surface roughness and sharp edges have to be prevented, in particular such forms with rounded structures are preferable, i.e. for example the form according to FIG. 1B with an upright circular cylinder as geometric basic form.

Aspects concerning the charge of the control electrode arrangement are basically independent of the choice of the form of the lateral surface.

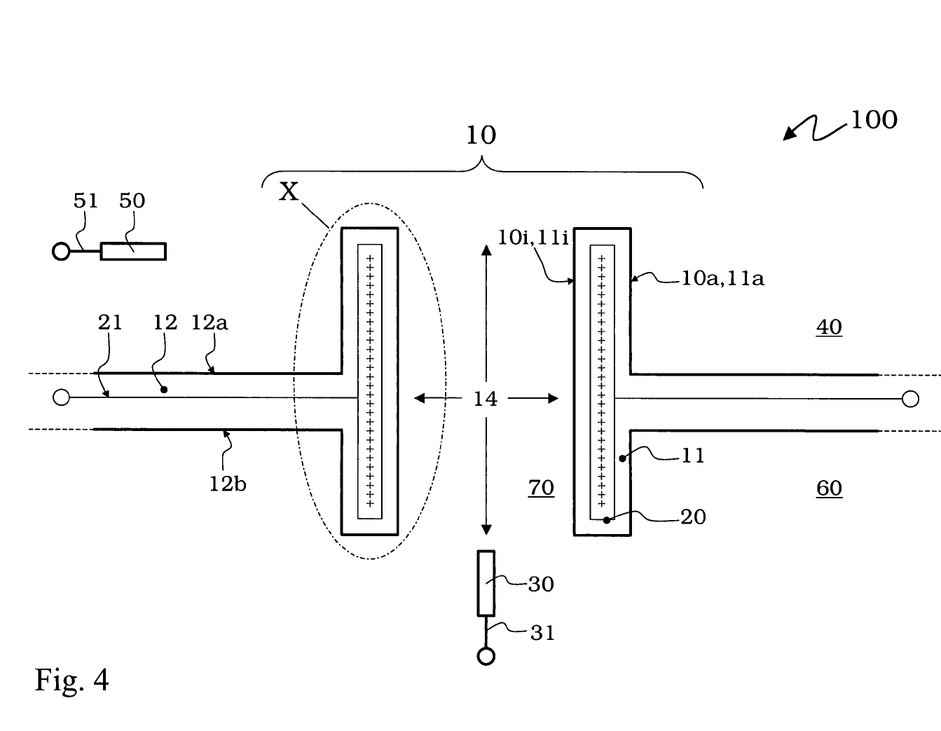

FIGS. 3 and 4 show in analogue manner to FIG. 1A and also in schematic and sectioned side view other embodiments of the measuring arrangement according to the invention, where a difference exists in that respect that according to FIG. 3 the wall region 11 for the aperture 14 is flush with the upper side 12a of the substrate 12 and protrudes exclusively beyond the lower side 12b of the substrate 12 such that altogether a kind of invagination of the upper side 12a to the inside in direction to the compartment 60 is generated for the aperture 14.

In FIG. 4 a part of the wall region 11 of the aperture 14 protrudes on the upper side 12a of the substrate 12 into the compartment 40, however, on the other hand also a part of the wall region 11 protrudes from the lower side 12b of the substrate 12 into the compartment 60.

The heights with respect to the upper side 12a and the lower side 12b by which the wall region 11 for the aperture 14, respectively, protrudes may be identical. However, this is not mandatory. In FIG. 4 they are differently formed.

In the embodiments of FIG. 1A as well as 3 and 4 the cross section or diameter along the extension direction of the wall region 11 is perpendicular to the upper side 12a or perpendicular to the lower side 12b of the substrate 12 constant in its profile.

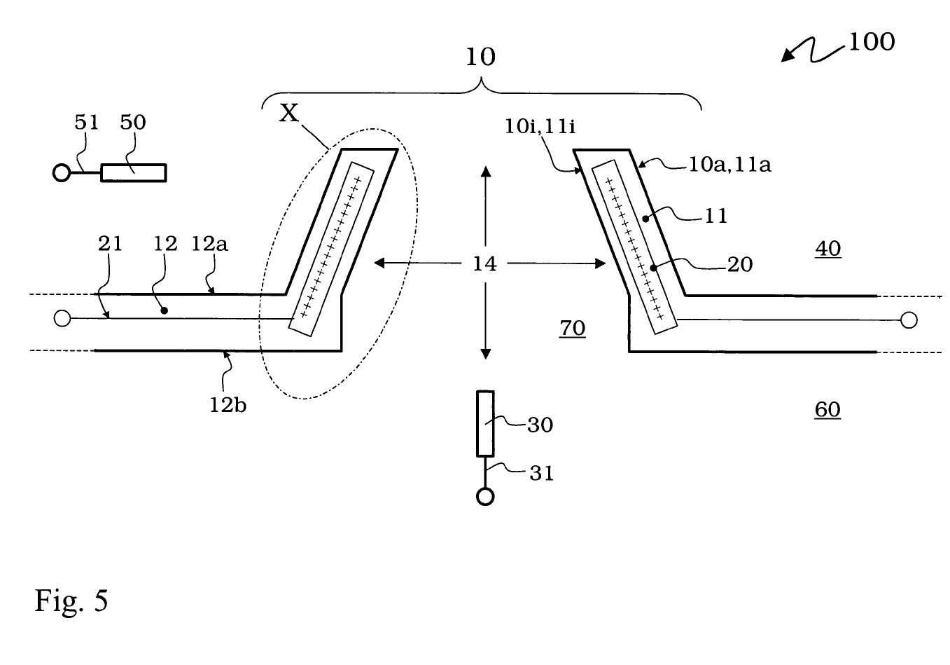

Also this is not mandatory. Tapering or broadening cross-sectional profiles may be provided. This is illustrated in the sequence of FIGS. 5 to 7, wherein FIG. 5 shows an embodiment of the measuring arrangement according to the invention, which corresponds to the embodiment of FIG. 1, however, with a cross-sectional profile of the aperture 14, which is narrowed with increasing distance from the upper side 12a.

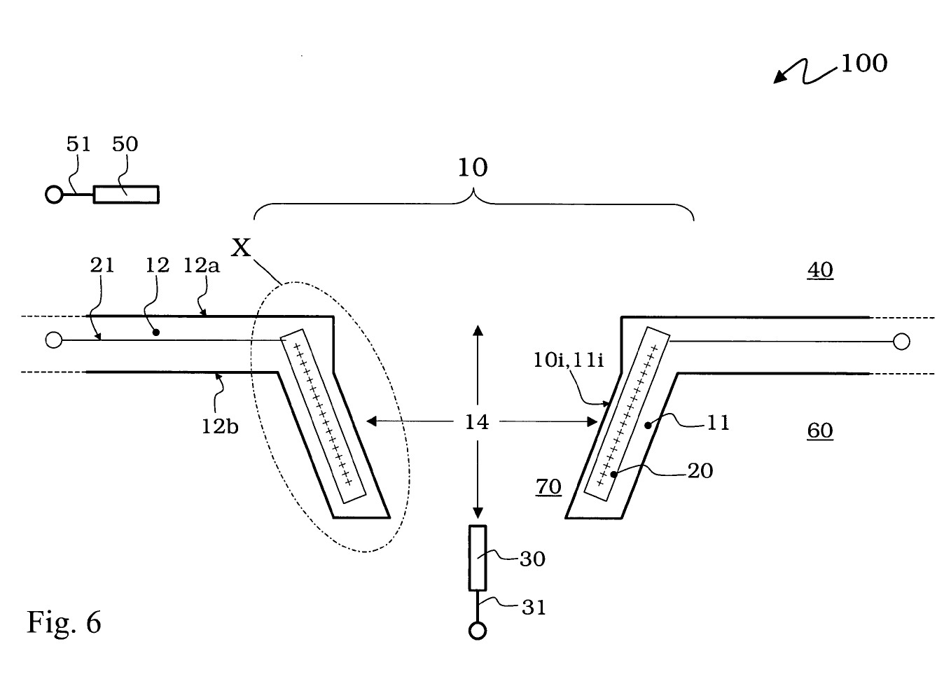

In contrast, in the embodiment of FIG. 6 in analogy and in comparison to the embodiment of FIG. 3 the aperture 14 is formed such that the cross-sectional profile tapers in distance from the lower side 12b of the substrate 12.

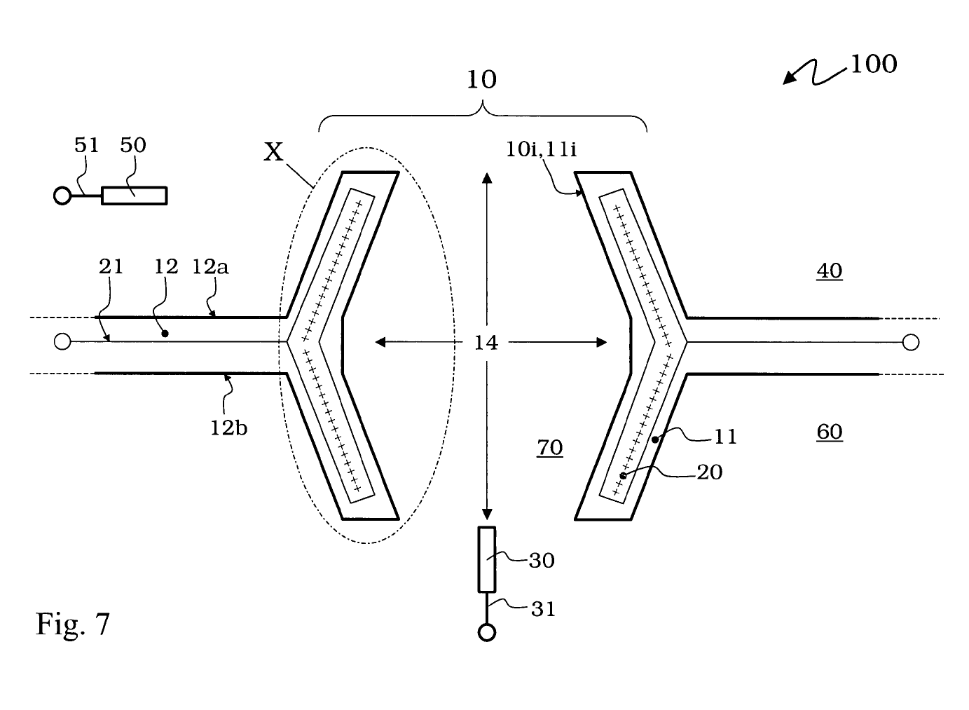

In combination of the embodiments of FIGS. 5 and 6 and in analogue view to the embodiment of FIG. 4, FIG. 7 shows an aperture 14, which has a maximal diameter of the aperture 14 at the height of the substrate 12 and tapers with increasing distance from the upper side 12a of the substrate 12 as well as from the lower side 12b of the substrate 12.

In the embodiment of FIG. 1A the measurement electrode 30 with the connection or conductor 31 is formed very close to and partially inserted into the aperture region with the aperture 14. The position of the measurement electrode 30 may vary, for example it may be inserted deeper into the electrolyte region 70 within the aperture 14 or may be more distant from it.

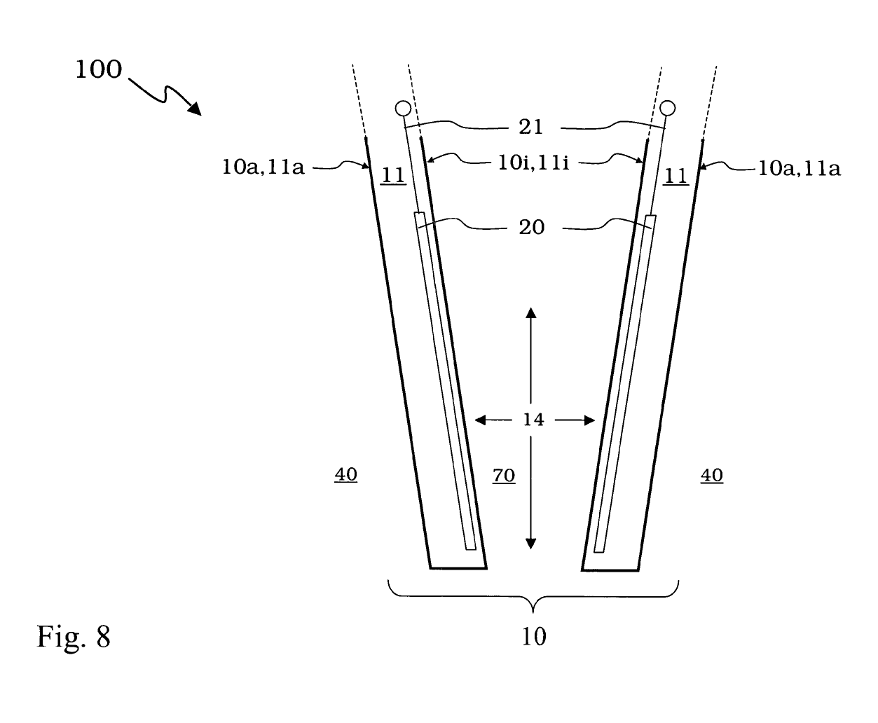

FIG. 8 shows in schematic and sectioned side view an embodiment of the electrophysiological measuring arrangement 100 according to the invention, where the aperture region 10 is formed of a wall region 11, which is formed altogether in the manner of a patch pipette.

Also in this case the inner wall region 10i, 11i, which is facing the aperture 14, as well as an outer wall region 10a, 11a are present, wherein the outer wall region 10a, 11a is facing during operation an electrolyte compartment 70 of the bath 40, 60, 70, which lies outside, and wherein the inner wall region 10i, 11i is facing the electrolyte compartment 70 of the bath 40, 60, 70, which is provided within the aperture. Within the wall region 11 and hence electrically isolated from the electrolyte bath 40, 60, 70 a control electrode arrangement 20 connected via conductor 21 is formed, too, which is capable to generate a surface charge at least on the inner wall 10i, 11i of the wall region 11 via application of an electric potential, to prevent or to support by this a sealing depositing of a biological object O to be analyzed.

Also in this case the procedure and the effect of charging have to be considered in principle separated from the form of the aperture 14.

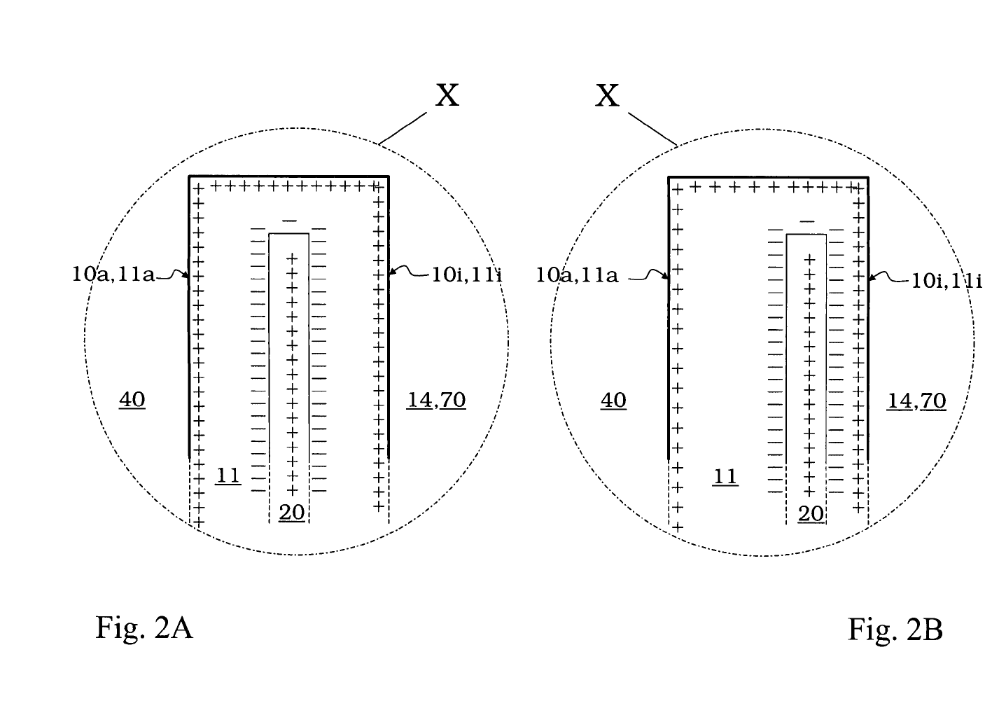

FIGS. 2A and 2B show in more detail section X of FIG. 1A, namely inducing a —here positive—surface charge on the inner side 10i, 11i and the outer side 10a, 11a by applying a—here positive—electric charge to the control electrode arrangement 20.

In FIG. 2A the control electrode arrangement 20 is formed and arranged symmetrically with respect to the thickness of the wall region 11. Thus, on the inner wall 10i, 11i and on the outer wall 10a, 11a positive charge densities of the same strength are generated. In the embodiment according to FIG. 2B the control electrode arrangement 20 is in contrast formed and arranged closer to the inner wall 10i, 11i or inner side 10i, 11i of the wall region 11 such that because of the larger distance to the outer wall 10a, 11a as smaller positive charge density is generated there than on the inner wall 10i, 11i.

FIGS. 9A to 9E show in schematic and sectioned side view different measurement principles, which may be used in the electrophysiological measuring arrangement 100 according to the invention and in the corresponding electrophysiological measuring method according to the invention.

Starting from the situation as illustrated in FIG. 9A, wherein due to light aspiration of the electrolyte bath 40, 60, 70 by the measurement aperture 14, i.e. with a suction from compartment 40 over compartment 70 within the aperture 14 to compartment 60, a biological object O, in this case for example a cell, is aspirated and approximated to the aperture 14.

The mechanism of approximation may also be performed in a different manipulative manner, for example via a separate pipette, a laser forceps or the like.

Via a small underpressure according to FIG. 9B the cell is completely deposited without any destruction to the measurement aperture 14. If a measurement is performed in this state, it is called a so-called cell-attached-mode.

By a mechanic draw, starting from the situation described in FIG. 9B, a membrane spot may be ruptured from the membrane of the biological object O such that the ruptured membrane spot, a so-called patch, remains within the sealed state inside the measurement aperture 14 and forms the actual measurement object O. In this process, the side of the membrane spot located in the interior before, points outwardly due to the rupturing, i.e. towards the compartment 40. For this reason this measurement mode is called also inside-out-mode.

On the other hand, starting from the situation illustrated in FIG. 9B due to a renewed underpressure, namely e.g. in the manner of a pressure pulse, the cell O may be opened all together such that a transition happens from the so-called cell-attached-mode to the whole-cell-mode, in which the measurement electrode 30 has direct access to the whole inside of the cell. This means that the inside of the cell is opened towards compartments 70 and 60, but is isolated basically with respect to compartment 40.

Starting from the situation according to FIG. 9D, namely from the whole-cell-mode by mechanical draw it may be achieved that again a membrane fragment is ruptured from the membrane of the biological object. As the whole-cell-mode was present before, it exists a certain probability that in this process the ruptured membrane spot remains such in the measurement aperture 14 that it may serve as the actual measurement object O and that according to FIG. 9E the outer side of the cell membrane or the membrane of the biological object still remains outside. In this case one speaks of the outside-out-mode of the measuring arrangement 100.

FIG. 10 illustrates once again in detail the geometric situation, which is present during a sealing depositing of a biological object to be measured between its membrane M and the measurement aperture 14 and in particular the inner wall 10i, 11i of the wall region. FIG. 10 shows again a whole-cell-mode, where the whole cell O is opened with its interior towards the measurement electrode 30 and towards the electrolyte compartments 60 and 70. This embodiment of the electrophysiological measuring arrangement 100 according to the invention is formed here in the manner of a patch pipette.

According to the invention the sealing resistance between the cell membrane M of the biological object O to be measured and the inner wall 10i, 11i of the wall region 11 of the measurement aperture 14 is improved by the fact that a charge opposed to the surface charge of the cell membrane M, i.e. here the charge at the outer side of the cell membrane M, is formed at the inner side of the wall 10i.

This means that in case of a negatively charged membrane M of the biological object O the inner wall 10i, 11i of the wall region 11 of the aperture 14 has to be positively charged, which happens by a positive charging of the control electrode 20 via the conductor 21.

Is, in contrast, the cell membrane M of the biological object O to be deposited positively charged, then the inner side of the wall 10i, 11i of the wall region 11 of the aperture 14 has to be charged negatively, which requires a negative charging of the control electrode arrangement 20 via the conductor 21.

If a depositing and hence a seal should be prevented, for example during a preparing phase for an experiment, the surface charge of the inner wall 10i, 11i of the wall region 11 of the aperture 14 has to be charged by the same charge type as the charge at the surface of the membrane M of the biological object O.

Hence, according to the invention it is possible to allow for different situations at different surfaces of membranes, may it be cell membranes, membranes of organelles or membranes of artificial objects. This was not possible up to now and provides a possibility to controllably prevent or to support depositing and sealing, or if a seal is once generated, to stabilize it.

In the embodiment according to FIG. 11 the substrate is quasi covered by a layer of the cell O′. By the mechanic and/or electric interaction under use of the control electrode arrangement 20 according to the invention, provided inside of the aperture wall 11, and its controlled charging, a singe cell O of the assemble of cells O′ is available as measurement object in the whole-cell mode in analogy to the situation according to FIG. 9D to an electrophysiological measurement with improved sealing depositing.

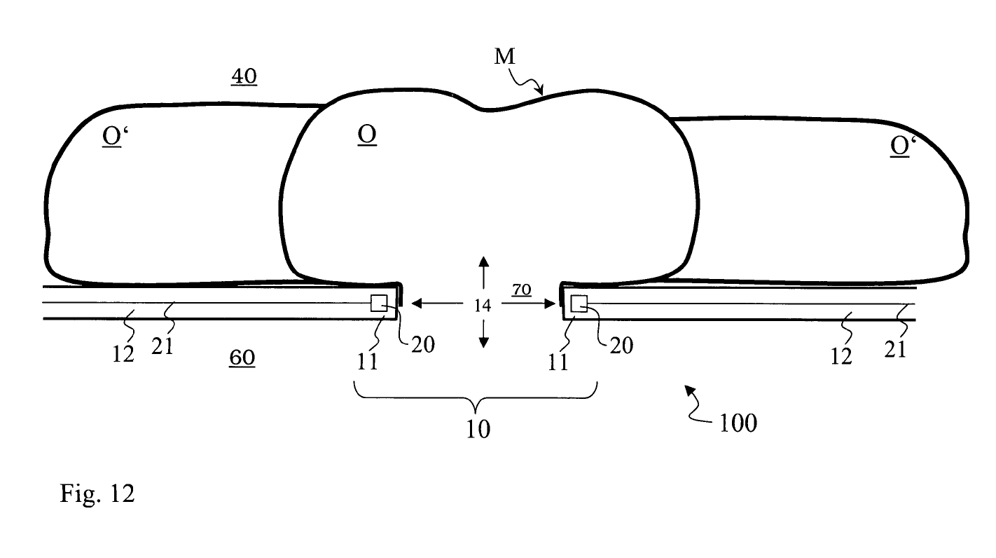

FIG. 12 shows an arrangement of the measuring arrangement 100 according to the invention, where the wall region 11 forming an aperture 14 is formed by an edge or edge region such that the aperture 14 is formed quasi as a planar hole within the underlying substrate 12 and wherein in this process the control electrode arrangement 20 applies an according surface charge to the edge region to influence depositing and sealing in a supporting or inhibiting manner.

### LIST OF REFERENCE NUMERALS

10 aperture region
10a outer wall, outer wall region, outer side of the aperture region 10
10i inner wall, inner wall region, inner side of the aperture region 10
11 wall region, wall
11i inner wall, inner wall region, inner side of the wall region 11
11a outer wall, outer wall region, outer side of the wall region 11
12 substrate, support, base, basic substrate
12a upper side, front side
12b lower side, rear side
14 aperture, measurement aperture
20 control electrode arrangement, charge electrode arrangement, control electrode, charge electrode
21 conductor, control conductor
30 measurement electrode, measurement electrode arrangement
31 measurement conductor, conductor,
40 electrolyte compartment, electrolyte bath
50 counter-electrode, counter-electrode arrangement
51 conductor
40 electrolyte compartment, electrolyte bath
60 electrolyte compartment, electrolyte bath
70 electrolyte compartment, electrolyte bath
100 electrophysiological measuring arrangement
M membrane of the biological object O
O biological object, cell, liposome, vesicle, micelle, oocyte, measurement object
O′ biological object, cell, liposome, vesicle, micelle, oocyte

1-10. (canceled)

11. A support for an electrophysiological measuring arrangement, comprising:
an aperture region for controllable sealing depositing of a biological object, the aperture region comprising at least one aperture and a wall region, the wall region surrounding an aperture to form the aperture region; and
a control electrode arrangement embedded in an interior of the wall region,
wherein an electric potential can be applied to the control electrode arrangement in a controllable manner such that at least an inner wall of the wall region, which faces the aperture, can be controllably formed with a surface charge such that the sealing depositing of the biological object at the aperture region is controllable.

12. The support of claim 11,
wherein the aperture region is formed in a region of the support which comprises an upper side and a lower side, and
wherein the wall region forming the aperture region partially or completely protrudes with respect to the upper side and/or with respect to the lower side of the support.

13. The support of claim 11,
wherein the wall region is formed in a lateral surface or as a combination of lateral surfaces.

14. The support of claim 13,
wherein the wall region is formed in a lateral surface of one of a cylinder, a prism, a truncated cone, and a truncated pyramid.

15. The support of claim 11,
wherein the wall region comprises a material selected from the group consisting of glass, quartz glass, silicone, and carbon.

16. The support of claim 11,
wherein the control electrode arrangement comprises one or more electrode elements integrated within the wall region.

17. The support of claim 16,
wherein the control electrode arrangement is formed as circles or stripes.

18. The support of claim 11,
wherein the control electrode arrangement is asymmetric with respect to a wall thickness of the wall region.

19. The support of claim 11,
wherein the control electrode arrangement is arranged closer to the inner wall which faces the aperture.

20. The support of claim 11,
wherein the control electrode arrangement comprises at least one material selected from the group consisting of gold, tantalum, platinum, gold-tantalum-platinum, doped polysilicon, indium tin oxide, and electrically conductive organic materials.

21. The support of claim 11,
wherein an inner diameter of the wall region ranges from about 1 μm to about 50 μm.

22. The support of claim 11,
wherein the wall region has a height or depth with respect to an upper side or a lower side of the support in a range of about 0 μm to about 20 μm.

23. An electrophysiological measuring arrangement, comprising:
a support comprising:
an aperture region for controllable sealing depositing of a biological object, the aperture region being formed with at least one aperture and a wall region, the wall region surrounding an aperture to form the aperture region; and
a control electrode arrangement embedded in an interior of the wall region,
wherein an electric potential can be applied to the control electrode arrangement in a controllable manner such that at least an inner wall of the wall region, which faces the aperture can be controllably formed with a surface charge such that the sealing depositing of the biological object at the aperture region is controllable;
a measurement electrode in a region or within the aperture, or in a region at a lower side of the support; and
a counter-electrode outside of the aperture in a region at an upper side of the support.

24. An electrophysiological measuring method using an electrophysiological measuring arrangement that includes a support having an aperture region for controllable sealing depositing of a biological object, the aperture region being formed with at least one aperture and a wall region, the wall region surrounding an aperture to form the aperture region, and a control electrode arrangement embedded in an interior of the wall region, a measurement electrode in a region or within the aperture, or in a region at a lower side of the support, and a counter-electrode outside of the aperture in a region at an upper side of the support, wherein a biological object to be measured is deposited at the aperture, wherein for controlling a sealing depositing of the biological object an inner wall of the wall region is formed in a controlled manner with an accordingly suited surface charge, and wherein for preventing or supporting of sealing depositing according to the type of the biological object to be measured a negative or positive surface charge and for supporting of a sealing depositing a positive or negative surface charge is formed, the method comprising:
providing adhered or suspended biological objects on the support;
aspirating and sucking in of a membrane of a biological object located in a region of the aperture via the aperture by an underpressure;
charging electrode elements of the control electrode arrangement; and
by lateral attraction of aspirated and sucked in parts of the membrane and sealing depositing of the aspirated and sucked in parts of the membrane to the inner wall of the aperture, performing an electrophysiological measurement of the biological object located in the region of the aperture.
